(19) United States
(12) Patent Application Publication
(10) Pub. No.: US 2017/0063696 A1
(43) Pub. Date: Mar. 2, 2017

(54) DATA PACKET FLOW RULE FIELD RANGE OF AN APPLICATION SPECIFIC INTEGRATED CIRCUIT

(71) Applicant: Hewlett Packard Enterprise Development LP, Houston, TX (US)

(72) Inventors: Claudio Enrique Viquez, San Jose (CR); Pedro Elias Alpizar, San Jose (CR); Sergio Saborio Taylor, San Jose (CR)

(21) Appl. No.: 14/837,472

(22) Filed: Aug. 27, 2015

(51) Int. Cl. H04L 12/851; H04L 12/721; H04L 12/813

(52) U.S. Cl. CPC H04L 47/24; H04L 47/20; H04L 45/12

(57) ABSTRACT

In some examples, network switch includes a processing resource and a memory resource. The memory resource can include machine readable instructions to create a pointer to a memory address of a storage medium of a programmable ASIC, the memory address including a range of values for a flow rule field; receive a data packet to be matched against the flow rule; determine whether a value of the flow rule field for the received data packet falls within the range of values; and apply an action to the received data packet when it is determined that the flow rule field falls within the range of values.

### BACKGROUND

Computer networks can be used to allow networked devices, such as personal computers, servers, and data storage devices to exchange data. Computer networks often include intermediary datapath devices such as network switches, gateways, and routers, to flow traffic along selected datapaths for routing data between networked devices. Certain intermediary datapath devices can, for example, process data received by the device by modifying metadata information of the data, copying the data, and/or forwarding the data.

### BRIEF DESCRIPTION OF DRAWINGS

FIG. 1 is a diagram of a network, according to an example.

FIG. 2 is a flowchart for a method, according to an example.

FIG. 3 is a flowchart for a method, according to another example.

FIG. 4 is a flowchart for a method, according to another example.

FIG. 5 is a flowchart for a method, according to another example.

FIG. 6 is a diagram of network switch, according to an example.

FIG. 7 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Software-defined networking can allow for the decoupling of traffic routing control decisions (e.g., which port of a network switch should be used to forward traffic en route to a given destination) from the network's physical infrastructure. For example, in a Software-Defined Network (SDN), such traffic routing control decisions can be determined by an entity (e.g., a network controller) that is different from the routing device itself (e.g., the network switch tasked with forwarding the traffic). A network controller used in implementing an SDN (e.g., an SDN controller) can, for example, be programmed to: (1) receive dynamic parameters of the network from intermediary datapath devices (e.g., network switches), (2) decide how to route packets over the network, and (3) inform the devices about these decisions.

In certain SDN pipelines, such as pipelines used in the OpenFlow SDN protocol, tables can be used to match one or more fields of received packet to obtain a series of instructions to be applied to the received packets. The matched fields can, for example, include predefined header fields such as a Media Access Control (MAC) address, Internet Protocol (IP) address, Transfer Control Protocol (TCP)/User Datagram Protocol (UDP) ports, etc. The SDN controller can, for example, specify which value or values are to be matched, and can indicate whether a direct match value or an indirect match (e.g., a match using wildcards) is acceptable. If a user wants to match a number of values (e.g., N values) of a given field on an entry of an OpenFlow table, then the same number of matches (e.g., N matches) would be used to complete the task. Due to hardware limitations, the quantity of entries for a table can be limited and expensive.

Certain implementations of the present disclosure can allow for the use of ranges as match values in a network switch or other device. For example, a range of values for a flow rule field, such as for example TCP destination ports ranging from 0-40, can be matched using a single flow rule entry. Certain implementations of the present disclosure can allow for better management of hardware resources, since a single flow entry can be used to match multiple values of a field. Moreover, in some implementations, it can be easier to create more complex SDN networks without increasing the complexity of the configuration. For example, rules configuration can stay the same but a broader field of values can be applied. Moreover, in some implementations, range intersections (e.g., an intersection between 2-4 and between 3-6, which would include 3-4) can be implemented for specific packet fields. Other advantages of implementations presented herein will be apparent upon review of the description and figures.

In one implementation, a method, which can for example be implemented by a network switch, can include: (1) associating a flow rule field with a range of a range table, the range table being locally stored on a programmable Application-Specific Integrated Circuit (ASIC); (2) storing a flow rule field value for a received data packet; (3) accessing the range from the range table; and (4) determining whether the stored flow rule field value falls within the accessed range. In some implementations, the range table as well as other elements of the network switch can, for example, be remotely configured using an SDN controller in communication with the network switch.

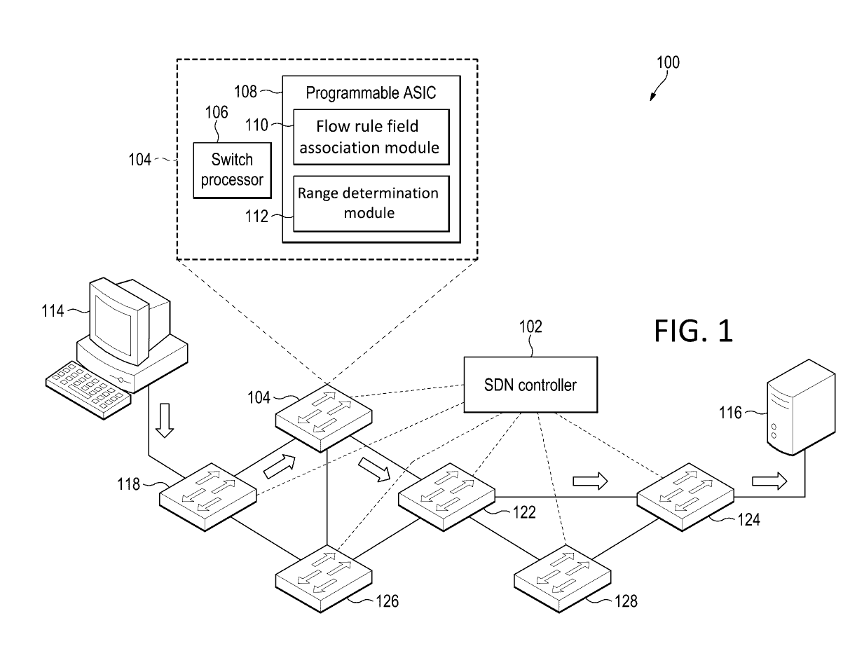

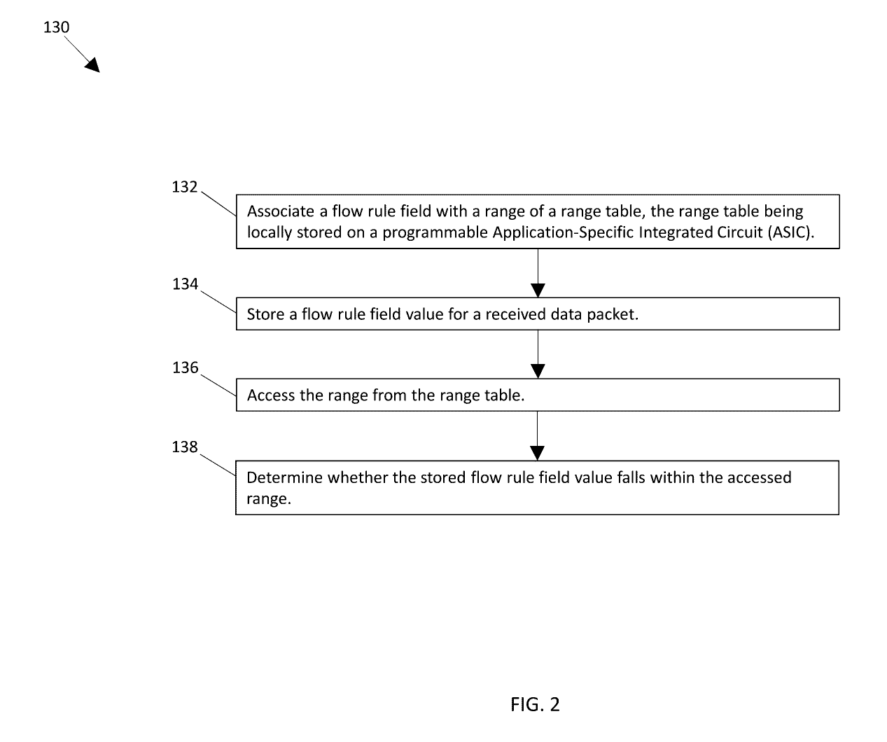

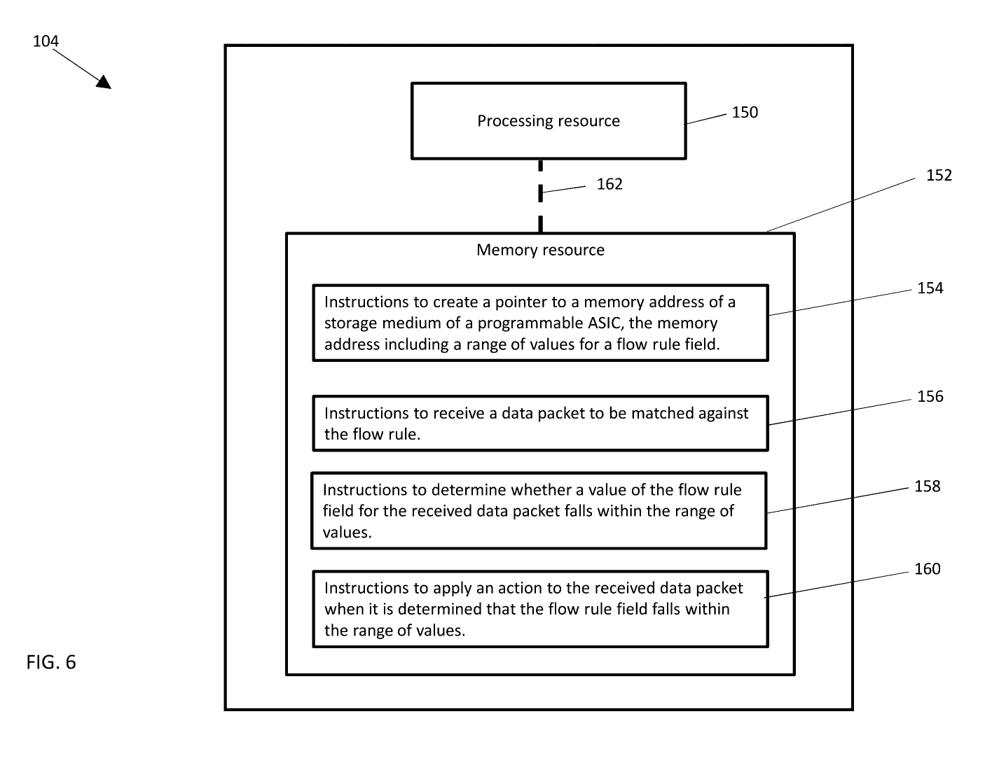

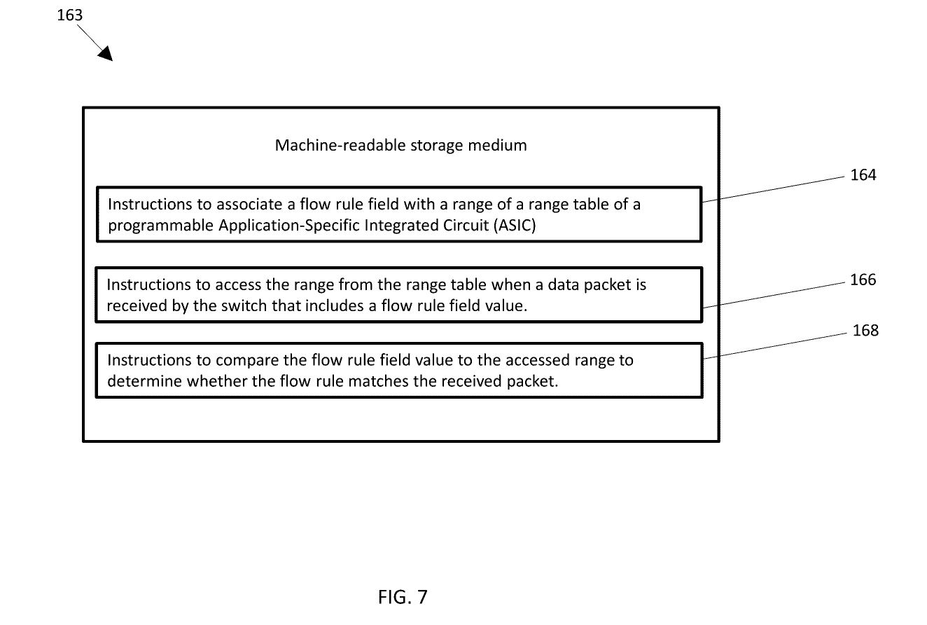

FIG. 1 is a diagram of an example SDN 100 including an example SDN controller 102 as well as an example network switch 104 including (among other components) a switch processor 106 in communication with a programmable ASIC 108 having various combined hardware/software modules 110 and 112. Module 110 can, for example, be in the form of a flow rule field association module that is able to associate a flow rule field with a range of a range table, the range table being locally stored on ASIC 108. Module 112 can, for example, be in the form of a range determination module to determine whether the stored flow rule field value falls within the accessed range. Further details regarding the functionality of modules 110 and 112 as well as the structure and functionality of network switch 104 are provided below with respect to the methods of FIGS. 2-5, the switch of FIG. 6, the medium of FIG. 7, and other implementations described herein.

FIG. 1 depicts traffic along a datapath between an example source node 114 and example destination node 116, the datapath being defined by network nodes 118, 104, 122, and 124. Other network nodes, such as nodes 126 and 128 can be included within SDN 100 but are not used in this example datapath. It is appreciated that the datapath can be determined by SDN controller 102 based on one or more static parameters, such as link speeds and number of hops between the nodes and can further (or alternatively) be based on one or more dynamic parameters, such as Quality of Service (QoS), network latency, network throughput, network power consumption, etc.

As provided above, network nodes within SDN 100 can forward traffic along the datapath based on metadata within the traffic. For example, traffic in the form of a packet can be received at network switch 104 (or another suitable intermediary network node). For consistency, the industry term “packet” is used throughout this description, however, it is appreciated that the term “packet” as used herein can refer to any suitable protocol data unit (PDU). Such a packet can, for example, include payload data as well as metadata in the form of control data. Control data can, for example, provide data to assist the network node with reliably delivering the payload data. For example, control data can include network addresses for source node 114 and destination node 116, error detection codes, sequencing information, packet size of the packet, a time-to-live (TTL) value, etc. In contrast, payload data can include data carried on behalf of an application for use by source node 114 and destination node 116.

As provided above, in an SDN (such as for example SDN 100), control decisions for routing traffic through the network can be decoupled from the network's physical infrastructure. For example, SDN controller 102 can be used to instruct network nodes to flow traffic along a selected routing path defined by the nodes. In some implementations, these nodes can, for example, be in the form of network switches or other intermediary network devices. The use of such software-defined networking can provide other functionality. For example, one or more SDN applications can be installed on or interface with SDN controller 102 to meet customer use cases, such as to achieve a desired throughput (or another QoS) over SDN 100, enforce security provisions for SDN 100, provide SDN optimization, provide SDN visualization, network tapping, network monitoring, management, deep packet inspection, and/or provide another suitable service or functionality.

The functionality of SDN controller 102 can, for example, be implemented in part via a software program on a standalone machine, such as a standalone server. In some implementations, SDN controller 102 can be implemented on multi-purpose machines, such as a suitable desktop computer, laptop, tablet, or the like. In some implementations, SDN controller 102 can be implemented on a suitable non-host network node, such as certain types of network switches. It is appreciated that the functionality of SDN controller 102 may be split among multiple controllers or other devices. For example, SDN 100 is described and illustrated as including only one SDN controller 102. However, it is appreciated that the disclosure herein can be implemented in SDNs with multiple controllers. For example, in some SDNs, network devices are in communication with multiple controllers such that control of the network can be smoothly handed over from a first controller to a second controller if a first controller fails or is otherwise out of operation. As another example, multiple controllers can work together to concurrently control certain SDNs. In such SDNs, a first controller can, for example, control certain network devices while a second controller can control other network devices. In view of the above, reference in this application to a single SDN controller 102 that controls the operation of SDN 100 is intended to include such multiple controller configurations (and other suitable multiple controller configurations).

Source node 114 and destination node 116 can, for example, be in the form of network hosts or other types of network nodes. For example, one or both of source node 114 and destination node 116 can be in the form of suitable servers, desktop computers, laptops, printers, etc. As but one example, source node 114 can be in the form of a desktop computer including a monitor for presenting information to an operator and a keyboard and mouse for receiving input from an operator, and destination node 116 can be in the form of a standalone storage server appliance. It is appreciated that source node 114 and destination node 116 can be endpoint nodes on SDN 100, intermediate nodes between endpoint nodes, or positioned at other logical or physical locations within SDN 100.

The various intermediary nodes within SDN 100 can, for example, be in the form of switches or other multi-port network bridges that process and forward data at the data link layer. In some implementations, one or more of the nodes can be in the form of multilayer switches that operate at multiple layers of the Open Systems Connection (OSI) model (e.g., the data link and network layers). Although the term “network switch” is used throughout this description, it is appreciated that this term can refer broadly to other types of suitable network data forwarding devices. For example, a general purpose computer can include suitable hardware and machine-readable instructions that allow the computer to function as a network switch. It is appreciated that the term “switch” can include other network datapath elements in the form of suitable routers, gateways and other devices that provide switch-like functionality for SDN 100.

The various nodes within SDN 100 are connected via one or more data channels, which can, for example be in the form of data cables or wireless data channels. Although a single link (i.e., a single line in FIG. 1) between each network node is illustrated, it is appreciated that each single link may include multiple wires or other wired or wireless data channels. Moreover, FIG. 1 further depicts SDN controller 102 as being connected to each network nodes via broken lines, which is intended to illustrate control channels between SDN controller 102 and respective nodes. However, it is appreciated that SDN controller 102 may be directly connected to only one or a few network nodes, while being indirectly connected to other nodes of SDN 100. As but one example, SDN controller 102 can be directly connected to node 122 via an Ethernet cable, while being indirectly connected to node 104 (e.g., by relying on node 122 as an intermediary for communication with node 104).

Within the context of an SDN (e.g., SDN 100), controlled network nodes can be used as sensors in the network as they have information about dynamic network parameters. When polled via standard SDN interfaces the devices can report this information to the SDN controller. SDN 100 can, for example, be implemented through the use of SDN controller 102 that interfaces with various SDN-compatible devices via a suitable Application Program Interface (“API”), or another suitable protocol (e.g., OpenFlow). In some implementations, SDN controller 102 may interface with controlled network devices via an interface channel that connects each controlled device to SDN controller 102 to allow SDN controller 102 to configure and manage each device, receive events from each device, and send packets using each device.

As used herein, the term “controlled” and similar terminology in the context of SDN-compatible network nodes, such as “controlled switches,” is intended to include devices within the control domain of SDN controller 102 or otherwise controllable by SDN controller 102. Such a controlled node can, for example, communicate with SDN controller 102 and SDN controller 102 is able to manage the node in accordance with an SDN protocol, such as the OpenFlow protocol. For example, an OpenFlow-compatible switch controlled by SDN controller 102 can permit SDN controller 102 to add, update, and delete flow entries in flow tables of the switch using suitable SDN commands.

In the example SDN 100 depicted in FIG. 1, the various network nodes are in the form of intermediary nodes (e.g., controlled network switch 104) and host devices (source node 114 and destination node 116). It is appreciated however, that the implementations described herein can be used or adapted for networks including more or fewer devices, different types of devices, and different network arrangements. It is further appreciated that the disclosure herein can apply to suitable SDNs (e.g., certain hybrid or heterogeneous SDNs) in which some devices are controlled by an SDN controller (e.g., SDN controller 102) and some devices are not controlled by the SDN controller (e.g., SDN controller 102 or any other SDN controller 102). For example, in some implementations, at least one node (e.g., node 104) along a given datapath is controlled by SDN controller 102 and at least one node along the given datapath (e.g., node 122) is not controlled by SDN controller 102.

FIG. 2 illustrates a flowchart for a method 130 according to an example of the present disclosure. For illustration, the description of method 130 and its component blocks make reference to example SDN 100 and elements thereof, such as for example SDN controller 102, network switch 104, etc., however, it is appreciated that method 130 or aspects thereof can be used or otherwise applicable for any suitable network or network element expressly described herein or otherwise. For example, method 130 can be applied to computer networks with different network topologies than those illustrated in FIG. 1.

In some implementations, method 130 can be implemented or otherwise executed through the use of executable instructions stored on a memory resource (e.g., the memory resource of the network switch of FIG. 6), executable machine readable instructions stored on a storage medium (e.g., the medium of FIG. 7), in the form of electronic circuitry (e.g., on an ASIC), and/or another suitable form. Although the description of method 130 herein primarily refers to steps performed on network switch 104 for purposes of illustration, it is appreciated that in some implementations, method 130 can be executed on another computing device within SDN 100 or in data communication with network switch 104.

Method 130 includes associating (at block 132) a flow rule field with a range of a range table. The range table, can, for example, be locally stored on a programmable ASIC, such as ASIC 108 of FIG. 1. The term “ASIC” as used herein can, for example, include related technologies such as application-specific field-programmable gate arrays (FPGAs), which can, for example contain an array of programmable logic blocks, and a hierarchy of reconfigurable interconnects that allow the blocks to be wired together. Suitable ASICs for use with the present disclosure can, for example, allow for logic blocks to be configured to perform complex combinational functions as well as simple logic gates like AND and XOR. Suitable ASICs for use with the present disclosure can, for example, also include memory elements, which may be simple flip-flops or more complete blocks of memory. In some implementations, ASIC 108 is configurable by SDN controller 102.

The term “associating” as used herein can, for example, refer to creating a pointer to a memory address of ASIC 108 (or another storage medium) for the location of the range. Other forms of associating can be used. For example, in some implementations, another type of programming language object reference that refers to another value stored elsewhere in a computer memory using its address (or another identifier) can be used. The range table can, for example, include one or more ranges, such as a range of values between 1 and 100. In some implementations, the values can be a range of discrete values (e.g., sequential port numbers). In some implementations, the values can be a range of more continuous values (e.g., time stamps, packet sizes, etc.).

The term “flow rule field” as used herein can, for example, refer to a specific header field of a data packet, such as for example a MAC addresses, IP address, etc., as well as specific metadata relating the data packet, such as ingress port of the packet, Virtual Local Area Network (VLAN) identifier, timestamp, packet size, etc.). For example, in one specific implementation, the flow rule field is a Transfer Control Protocol (TCP) destination port number for the data packet.

Method 130 includes storing (at block 134) a flow rule field value for a received data packet as well as accessing (at block 136) the range from the range table. The flow rule field value can, for example, be stored on a storage medium or other memory resource of switch 104. In some implementations, the flow rule field value is stored on a memory resource of ASIC 108 or on another memory resource of switch 104. In some implementations, the flow rule field value is stored on a memory resource that is remote from switch 104 but accessible by switch 104 via a data communication channel.

Method 130 includes determining (at block 138) whether the stored flow rule field value falls within the accessed range. As an example, a flow rule field value for a destination port 30 can be said to “fall within” an accessed range of destination ports between 20 and 40. The term “fall within” can, for example, be inclusive of boundary values, such as 20 and 40 in the above example. That is, in such an implementation, a flow rule field value for a destination port 20 can be said to fall within an accessed range of destination ports between 20 and 40, whereas a flow rule field value for a destination port 15 would not fall within the accessed range. An accessed range can provide for a direct value match (e.g., an IP address range between 194.66.82.11 and 194.66.82.50). In some implementations, the match can, for example, be a non-direct value match (e.g., through the use of one or more wildcards in the flow rule such as an IP address range between 194.66.*.11 and 194.66.*.50).

Although the flowchart of FIG. 2 shows a specific order of performance, it is appreciated that this order may be rearranged into another suitable order, may be executed concurrently or with partial concurrence, or a combination thereof. Likewise, suitable additional and/or comparable steps may be added to method 130 or other methods described herein in order to achieve the same or comparable functionality. In some implementations, one or more steps are omitted. For example, in some implementations, block 132 of associating a flow rule field with a range of a range table can be omitted from method 130. It is appreciated that blocks corresponding to additional or alternative functionality of other implementations described herein can be incorporated in method 130. For example, blocks corresponding to the functionality of various aspects of switch 104 otherwise described herein can be incorporated in method 130 even if such functionality is not explicitly characterized herein as a block in a method.

A specific example implementation will now be described. It is appreciated that this implementation may include certain aspects of other implementations described herein (and vice-versa), but it is not intended to be limiting towards other implementations described herein. An example implementation of method 130 can allow for certain actions such as associating, storing, accessing, and determining to be performed by an ASIC (e.g., ASIC 108) of switch 104. In some implementations, certain functions, such as for example the act of determining can be performed by a processor of a network switch that is separate from the ASIC. The ASIC can, for example, be configurable automatically or manually by an SDN controller or through another suitable way. For example, in some implementations, a keyboard and monitor can be plugged into a network switch that to allow a network administrator to configure an ASIC of the network switch. It is appreciated that in some implementations, the network switch can be configured remotely via a computer or other instrument in data communication with the network switch via data wire or other suitable data channel.

In one example implementation, a flow rule field value desired to be matched is a TCP destination port ranging from 1000 to 1500. In accordance with certain implementations of the present disclosure, only a single flow rule entry can be used to achieve this range. That is, when a range is used, only one rule is used to represent this collection of values. In this example, a range table is used to store ranges that will be used to create multiple value matches for a single flow entry. In this example, a range table is provided with multiple range values, each of which is associated with a minimum and maximum values along with a range value number or index. In this example, management software running on the switch receives a request from an SDN controller to match a range on a flow entry. In response, the management software will reserve a new range from the range table and associate this range with the flow entry. For example if the SDN controller wants to match TCP port destination ranging from 0 to 1000, the SDN management software will create a new range (e.g., Range “A”) in the range table and it will associate Range A with 0-1000. After this operation, the management software associates the flow entry field with a pointer to the range. For example, the management software can associate TCP port destination with Range A such that when a packet arrives that has a TCP port destination number between 0 to 1000 it will match the entry.

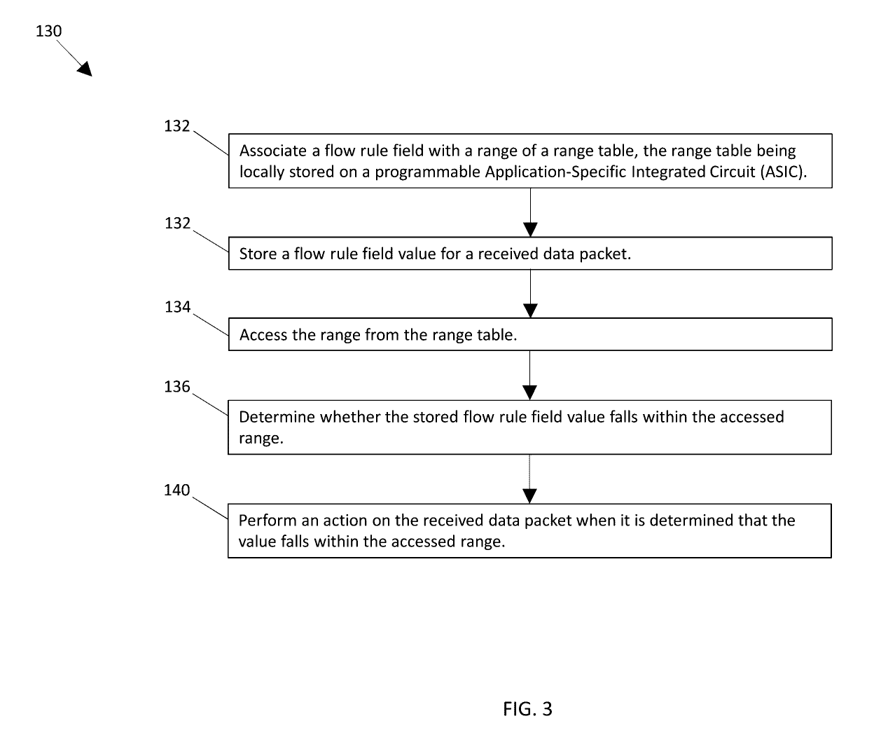

FIG. 3 illustrates another example of method 130 in accordance with the present disclosure. For illustration, FIG. 3 reproduces various blocks from method 130 of FIG. 2, however it is appreciated that method 130 of FIG. 3 can include additional, alternative, or fewer steps, functionality, etc., than method 130 of FIG. 2 and is not intended to be limited by the diagram of FIG. 2 (or vice versa) or the related disclosure thereof. It is further appreciated that method 130 of FIG. 3 can incorporate one or more aspects of method 130 of FIG. 2 and vice versa. For example, in some implementations, method 130 of FIG. 2 can include the additional step described below with respect to method 130 of FIG. 3.

Method 130 includes performing (at block 140) an action on the received data packet when it is determined that the value falls within the accessed range. As provided above, instructions can be attached to a flow entry and can describe packet processing to occur when a packet matches the flow entry. As used herein, the term “instruction” can, for example, refer to instructions to: (1) modify pipeline processing, such as directing the packet to another flow table, (2) contain a set of actions to add to the action set, (3) contain a list of actions to apply immediately to the packet, etc. As used herein, the term “action” can, for example, refer to an operation that forwards the packet to a port or modifies the packet, such as decrementing the TTL field. Actions can, for example, be specified as part of the instruction set associated with a flow entry or in an action bucket associated with a group entry. Multiple actions can, for example, be accumulated in the Action Set of the packet or can be applied immediately to the packet. As used herein, the term “action set” can, for example, refer to a set of actions associated with the packet that are accumulated while the packet is processed by each table and that are executed when the instruction set instructs the packet to exit the processing pipeline.

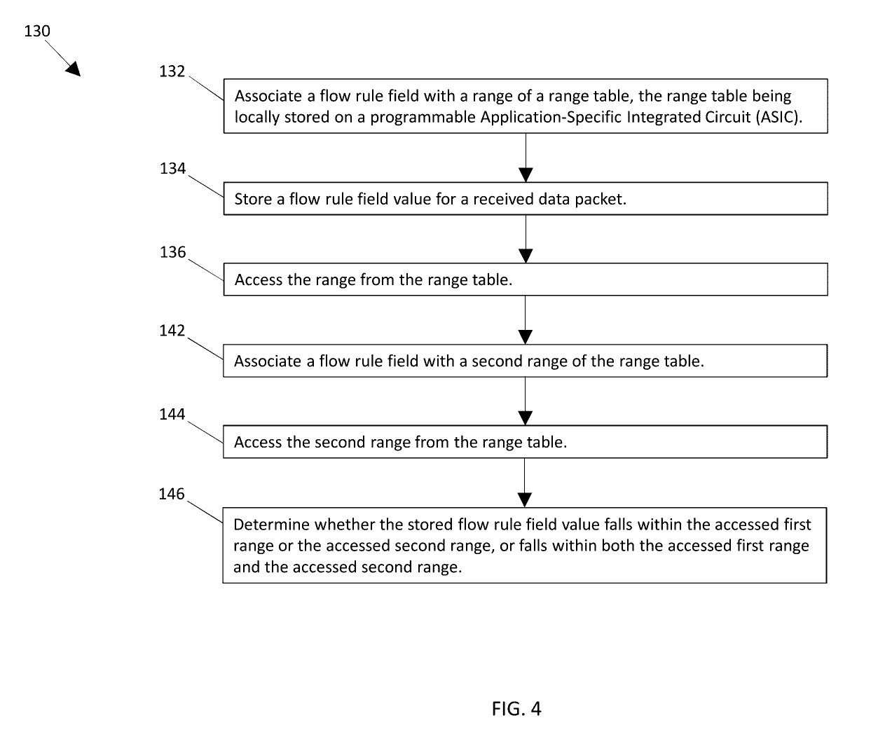

FIG. 4 illustrates another example of method 130 in accordance with the present disclosure. For illustration, FIG. 4 reproduces various blocks from method 130 of FIG. 2, however it is appreciated that method 130 of FIG. 4 can include additional, alternative, or fewer steps, functionality, etc., than method 130 of FIG. 2 and is not intended to be limited by the diagram of FIG. 2 (or vice versa) or the related disclosure thereof. It is further appreciated that method 130 of FIG. 4 can incorporate one or more aspects of method 130 of FIG. 2 and vice versa. For example, in some implementations, method 130 of FIG. 2 can include the additional step described below with respect to method 130 of FIG. 4.

Method 130 includes associating (at block 142) a flow rule field with a second range of the range table, accessing (at block 144) the second range from the range table, and determining (at block 146) whether the stored flow rule field value falls within the accessed first range or the accessed second range, or falls within both the accessed first range and the accessed second range. Such an implementation can, for example, allow for various ranges can be associated with an entry. In such a situation, a packet field can match the flow entry if its value is within the intersection of the ranges of interest. For example, if a first range for a TCP port destination is between 2 and 16 and a second range for a TCP port destination is between 10 and 80, then a packet will match if its TCP port destination is between 10 and 16 as this is the intersection between the two ranges. In some implementations, block 146 includes determining whether the stored flow rule field value falls within the accessed first range or the accessed second range. For example, suppose a first range “A” from 10-25 and a second range “B” from 45-80. The table entry can include a match rule of match on TCP Destination port=Range A or Range B. In such a situation, if a packet arrives with TCP Destination Port equal to 14, it will match the entry, however a packet with TCP destination port equal to 30 will not match the entry.

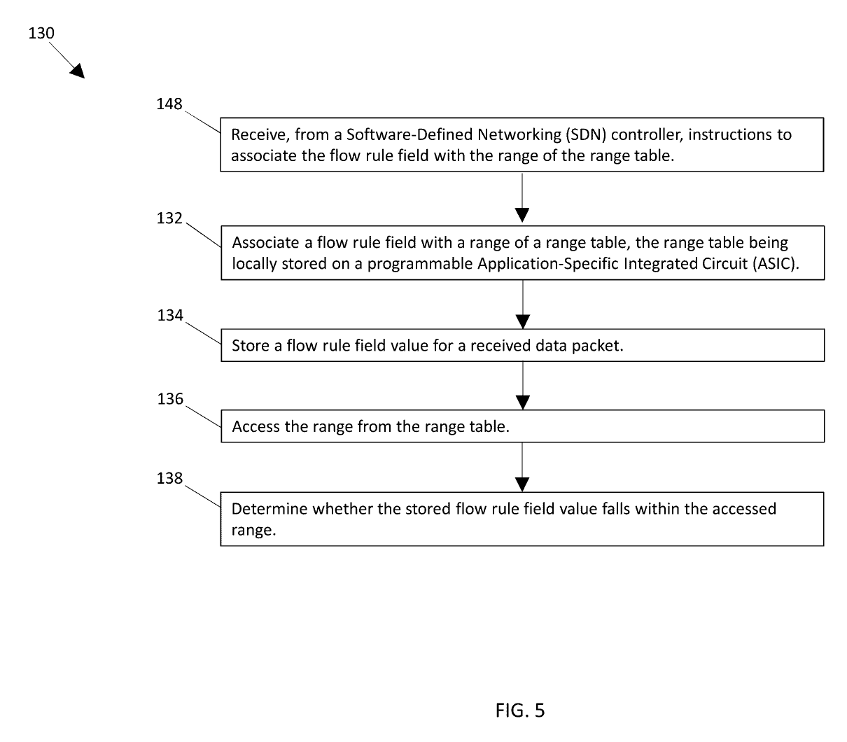

FIG. 5 illustrates another example of method 130 in accordance with the present disclosure. For illustration, FIG. 5 reproduces various blocks from method 130 of FIG. 2, however it is appreciated that method 130 of FIG. 5 can include additional, alternative, or fewer steps, functionality, etc., than method 130 of FIG. 2 and is not intended to be limited by the diagram of FIG. 2 (or vice versa) or the related disclosure thereof. It is further appreciated that method 130 of FIG. 5 can incorporate one or more aspects of method 130 of FIG. 2 and vice versa. For example, in some implementations, method 130 of FIG. 2 can include the additional step described below with respect to method 130 of FIG. 5.

Method 130 includes receiving (at block 148), from SDN controller 102, instructions to associate the flow rule field with the range of the range table. The instructions can, for example, be communicated to switch 104 via a dedicated control channel for sending control instructions between SDN controller 102 and switch 104. The instructions can, for example, be automatically generated by a module running on SDN controller 102 or can be created by a network administrator or other entity and merely forwarded by SDN controller 102.

FIG. 6 is a diagram of a network switch 104 in accordance with the present disclosure. As described in further detail below, network switch 104 includes a processing resource 150 and a memory resource 152 that stores machine-readable instructions 154, 156, 158, and 160. For illustration, the description of network switch 104 of FIG. 6 makes reference to various aspects of method 130 of FIGS. 2-5 (such as the ASIC identified above with respect to FIG. 1). Indeed, for consistency, the same reference number for the network switch of FIG. 1 is used for the network switch of FIG. 6. However it is appreciated that network switch 104 of FIG. 6 can include additional, alternative, or fewer aspects, functionality, etc., than the implementation described with respect to method 130 as well as the network switch of FIG. 1 and is not intended to be limited by the related disclosure thereof.

Instructions 154 stored on memory resource 152 are, when executed by processing resource 150, to cause processing resource 150 to create a pointer to a memory address of a storage medium of ASIC 108. The memory address can, for example, include a range of values for a flow rule field. Instructions 154 can incorporate one or more aspects of blocks of method 130 or another suitable aspect of other implementations described herein (and vice versa). Instructions 156 stored on switch memory resource 152 are, when executed by switch processing resource 150, to cause switch processing resource 150 to receive a data packet to be matched against the flow rule. Instructions 156 can incorporate one or more aspects of blocks of method 130 or another suitable aspect of other implementations described herein (and vice versa).

Instructions 158 stored on memory resource 152 are, when executed by processing resource 150, to cause processing resource 150 to determine whether a value of the flow rule field for the received data packet falls within the range of values. Instructions 158 can incorporate one or more aspects of blocks of method 130 or another suitable aspect of other implementations described herein (and vice versa). Instructions 160 stored on switch memory resource 152 are, when executed by switch processing resource 150, to cause switch processing resource 150 to apply an action to the received data packet when it is determined that the flow rule field falls within the range of values. Applying an action to the received data packet can, for example, include forwarding the received data packet through a specific port of a network switch in accordance with the flow rule. Instructions 160 can incorporate one or more aspects of blocks of method 130 or another suitable aspect of other implementations described herein (and vice versa).

In some implementations, switch 104 can further include instructions stored on memory resource 152 that, when executed by processing resource 150, cause processing resource 150 to process a received data packet and/or to forward the received data packets to another device in a network. Such instructions can, for example, rely on flow rules stored on switch 104 (or otherwise accessible by the switch) for forwarding or otherwise handling traffic.

Processing resource 150 of network switch 104 can, for example, be in the form of a central processing unit (CPU), a semiconductor-based microprocessor, a digital signal processor (DSP) such as a digital image processing unit, other hardware devices or processing elements suitable to retrieve and execute instructions stored in a memory resource, or suitable combinations thereof. Processing resource 150 can, for example, include single or multiple cores on a chip, multiple cores across multiple chips, multiple cores across multiple devices, or suitable combinations thereof. Processing resource 150 can be functional to fetch, decode, and execute instructions as described herein. As an alternative or in addition to retrieving and executing instructions, processing resource 150 can, for example, include at least one integrated circuit (IC), other control logic, other electronic circuits, or suitable combination thereof that include a number of electronic components for performing the functionality of instructions stored on a memory resource. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 150 can, for example, be implemented across multiple processing units and instructions may be implemented by different processing units in different areas of network switch 104.

Memory resource 152 of network switch 104 can, for example, be in the form of a non-transitory machine-readable storage medium, such as a suitable electronic, magnetic, optical, or other physical storage apparatus to contain or store information such as machine-readable instructions 154, 156, 158, and 160. Such instructions can be operative to perform one or more functions described herein, such as those described herein with respect to method 130 or other methods described herein. Memory resource 152 can, for example, be housed within the same housing as a respective processing resource for network switch 104, such as within a computing tower case for network switch 104. In some implementations, each memory resource and processing resource are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, each memory resource can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Processing resource 150 can be in communication with memory resource 152 via a communication link 162. Link 162 can, for example, be in the form of local communication links such as an electronic bus internal to a machine (e.g., a computing device). Other suitable forms of communication links can be provided.

In some implementations, one or more aspects of network switch 104 and SDN controller 102 can be in the form of functional modules that can, for example, be operative to execute one or more processes of instructions 154, 156, 158, or 160 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of a network switch 104 can, for example, include one or more machine-readable storage mediums and one or more computer processors.

In view of the above, it is appreciated that the various instructions of network switch 104 described above can correspond to separate and/or combined functional modules. For example, instructions 154 can correspond to a “pointer creation module” to create a pointer to a memory address of a storage medium of a programmable ASIC and instructions 158 can correspond to a “determination module” to determine whether a value of the flow rule field for the received data packet falls within the range of values. It is appreciated that modules corresponding to other instructions can be provided and that a given module can be used for multiple functions. As but one example, in some implementations, a single module can be used to both create a pointer (e.g., corresponding to the functionality of instructions) as well as to determine whether a value of a flow rule field for a received data packet falls within a range of values (e.g., corresponding to the functionality of instructions 158). Likewise, SDN controller 102 can include various modules corresponding to the various functions performed by SDN controller 102, such as a module to prepare and send to switch 104 instructions to associate a flow rule field with a range of the range table.

One or more nodes within SDN 100 (e.g., SDN controller 102, network switch 104, etc.) can further include a suitable communication module to allow networked communication between SDN controller 102, network switch 104, and/or other elements of SDN 100. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware of SDN controller 102, network switch 104, or other network equipment. The communication module can, for example, include machine-readable instructions for use with communication the communication module, such as firmware for implementing physical or virtual network ports.

FIG. 4 illustrates a machine-readable storage medium 163 including various instructions that can be executed by a computer processor or other processing resource. In some implementations, medium 163 can be housed within a network switch, such as a network switch 104, or on another computing device within SDN 100 or in local or remote wired or wireless data communication with SDN 100.

For illustration, the description of machine-readable storage medium 163 provided herein makes reference to various aspects of network switch 104 and other implementations of the disclosure (e.g., method 130). Although one or more aspects of network switch 104 (as well as instructions such as instructions 154, 156, 158, and 160) can be applied or otherwise incorporated with medium 163, it is appreciated that in some implementations, medium 163 may be stored or housed separately from such a system. For example, in some implementations, medium 163 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 163 includes machine-readable instructions 164 stored thereon to cause a processing resource to associate a flow rule field with a range of a range table of a programmable ASIC. Instructions 164 can incorporate one or more aspects of blocks of method 130 or another suitable aspect of other implementations described herein (and vice versa). Medium 163 further includes machine-readable instructions 166 stored thereon to cause a processing resource to access the range from the range table when a data packet is received by the switch that includes a flow rule field value. Instructions 166 can incorporate one or more aspects of blocks of method 130 or another suitable aspect of other implementations described herein (and vice versa). Medium 163 further includes machine-readable instructions 168 stored thereon to cause a processing resource to compare the flow rule field value to the accessed range to determine whether the flow rule matches the received packet. Instructions 168 can incorporate one or more aspects of blocks of method 130 or another suitable aspect of other implementations described herein (and vice versa).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
associating a flow rule field with a range of a range table, the range table being locally stored on a programmable Application-Specific Integrated Circuit (ASIC);
storing a flow rule field value for a received data packet;
accessing the range from the range table; and
determining whether the stored flow rule field value falls within the accessed range.

2. The method of claim 1, further comprising:
performing an action on the received data packet when it is determined that the value falls within the accessed range.

3. The method of claim 1, wherein the range is a first range, and wherein the method further comprises:
associating a flow rule field with a second range of the range table;
accessing the second range from the range table; and
determining whether the stored flow rule field value falls within the accessed first range or the accessed second range, or falls within both the accessed first range and the accessed second range.

4. The method of claim 1, further comprising:
receiving, from a Software-Defined Networking (SDN) controller, instructions to associate the flow rule field with the range of the range table.

5. The method of claim 1, wherein associating the flow rule field with the range includes creating a pointer to a memory address of the ASIC for the location of the range.

6. The method of claim 1, wherein the flow rule field is a Transfer Control Protocol (TCP) destination port number.

7. The method of claim 1, wherein the flow rule field is an Internet Protocol (IP) address.

8. The method of claim 1, wherein the flow rule field is a media access control (MAC) address.

9. The method of claim 1, wherein the act of associating, storing, accessing, and determining are performed by the ASIC.

10. The method of claim 1, wherein the act of determining is performed by a processor of a network switch that is separate from the ASIC.

11. The method of claim 1, wherein the ASIC is configurable by a Software-Defined Networking (SDN) controller.

12. A non-transitory machine readable storage medium having stored thereon machine readable instructions to cause a computer processor of a network switch to:
associate a flow rule field with a range of a range table of a programmable Application-Specific Integrated Circuit (ASIC);
access the range from the range table when a data packet is received by the switch that includes a flow rule field value; and
compare the flow rule field value to the accessed range to determine whether the flow rule matches the received packet.

13. The medium of claim 12, wherein the range includes a range of sequential port numbers.

14. A network switch comprising:
a processing resource;
a memory resource, wherein the memory resource includes machine readable instructions to:
create a pointer to a memory address of a storage medium of a programmable ASIC, the memory address including a range of values for a flow rule field;
receive a data packet to be matched against the flow rule;
determine whether a value of the flow rule field for the received data packet falls within the range of values; and
apply an action to the received data packet when it is determined that the flow rule field falls within the range of values.

15. The network switch of claim 14, wherein applying an action to the received data packet includes forwarding the received data packet through a specific port of a network switch in accordance with the flow rule.
